(19) United States
(12) Patent Application Publication
(10) Pub. No.: US 2007/0101554 A1
(43) Pub. Date: May 10, 2007

(54) Fastening device for scarves, headgear and the like

(76) Inventor: Paul E. O'Brien, Portsmouth, VA (US)

Correspondence Address: BRADLEY D. GOLDIZEN, 505 SOUTH INDEPENDENCE BOULEVARD, SUITE 102, VIRGINIA BEACH, VA, 23452, US

(21) Appl. No.: 11/269,406

(22) Filed: Nov. 8, 2005

(51) Int. Cl. F16G 11/00

(52) U.S. Cl. 24/129 R

(57) ABSTRACT

The instant fastener presents a novel way to secure fabric and other materials. The fastener comprises a fastener base having holes through which a lace or cord is intertwined for holding ends of a scarf, skullcap, bandana or other headgear together. Creating knots is common practice, but in certain applications it has disadvantages. Knots are difficult to adjust, maintain and disassemble, especially when one is doing so on a knot tied behind their head. The instant fastener eliminates these problems because of its simplicity and design. Additionally the fastener alleviates the discomfort associated with knots as well. Finally, the fastener improves on the prior art because it presents the user with an opportunity to individualize their securing device by embellishing it with beads or other accessories. Therefore, the present invention solves problems created by the prior art, and offers new improvements on the prior art.

There are no related applications.

The patent application did not receive federal research and development funding.

### BACKGROUND OF THE INVENTION

The present invention relates to a fastener comprising of a piece of material such as sturdy leather with specifically positioned openings, replete with an intertwining leather strip. This invention is intended to improve on common means of fastening scarves, thereby eliminating the discomfort commonly associated with such a task.

Fashion accessories, like scarves or bandanas, are often used to augment an individual's appearance. Beyond their aesthetic use, scarves are also utilized by adults and children plagued with cancer. Often these individuals rely on scarves to cover the hair loss caused by their chemotherapy treatments. To these individuals, scarves offer self-confidence in their appearance, but discomfort as well. Bikers also wear bandanas and skull caps under their helmets. The majority of scarves available in the general and specialty markets require the two ends to be tied together in the back. By securing the scarf in this way, the user may experience difficulty adjusting the knot. Moreover, when a helmet is worn over a head scarf, the knot may cause great discomfort. Additionally, tying the two ends into a knot can cause discomfort when the two tied ends get caught up in hair, or pinch the skin. In fact, because of the discomfort associated with tying a scarf on one's head, certain classes and Internet websites are devoted to explaining the least painful means of tying a scarf.

Despite the problems associated with creating the knot, there are also problems with maintaining and disassembling the knot. If the individual's scarf is made of silk or similar fabric, the material will not have enough friction to maintain the knot. Thus, the knot will slip out, making a good fit nearly impossible. In addition, disassembling the knot is a difficult and tedious task.

Finally, securing scarves by knotting the ends is damaging to the fabric itself. In the short term, knotting the scarf causes wrinkling requiring washing or ironing to restore the scarf to its usual appearance. And, over time tying the material into tight knots breaks the material down and negatively impacts its color and texture.

Looking to the prior art, it is clear that there is a need for a new and improved fastening method that causes the user less discomfort. The present invention presents the user this opportunity because it is comfortable and easy to use.

### BRIEF SUMMARY OF THE INVENTION

The present invention is preferably comprised of a sturdy leather base with an array of holes, preferably six small holes, two holes to a column by three rows. A leather strip or lace is wound through these holes creating two loops and two ends to allow for adjustments. These loops are fashioned by passing the two ends of the lace through two holes on one end and the backside of the base. These ends are crisscrossed on a front side of the base and one end goes through a middle row hole to allow for adjustments to that loop. The other goes to the opposite end and loops through both of the holes on that row to create a second loop on the back side of the base. The end is finally pulled through the remaining middle row hole to allow for adjustment to the second loop. Thus, the fastener is adjusted by merely moving the strip though the holes, thereby tightening or loosening the loops. It is important to realize that the loop is preferably created by passing a single end from one hole to another hole where both holes are located on a single row of the array of holes. However, it is recognized that the second hole for creating a loop may be on a separate row of holes depending on the size of the array.

A second embodiment of the invention has only one loop. The base includes only four openings in a two column by two row pattern. The strip is first passed through two holes from the back side to create a loop. Next the ends are crisscrossed on a front side of the base and the ends are passed through the second pair of holes to allow for adjustments.

In a further embodiment, the base includes a ten hole array, two columns by five rows. The base is folded across the middle row of holes through which an ornamental lace passes such that the first and second rows of holes overlap the third and fourth rows of holes, respectively, to create a two by two matrix of holes. An adjustment lace is then passed through these holes in the same manner as the second embodiment. The ornamental lace comprises two long leather strips that hang down from the base to further embellish this embodiment. These strips are merely ornamental and can be further enhanced by stringing beads or other decorations onto the strip. This embodiment is designed for children and creative individuals. It presents a fun opportunity to decorate and individualize their fastener. Thus, they can decorate it using their favorite colors, beads spelling their name, or in a certain theme.

The present invention offers several other advantages over prior options. First, the fastener eliminates the discomfort caused by knotting. Since the user does not need to manipulate the two ends into a knot, they cannot get any hair caught in the knot. Also, if their knot is not tight or loose enough once it is put on, the user must undo the knot and tie it again. The fastener is easier to use because if it is not perfectly adjusted the user merely has to tighten or loosen the strips. This ease of use makes achieving a comfortable fit much easier.

Also, the fastener is easier to secure than a knot because it is a more secure hold. The fastener also maintains a secure hold better than knots. Some fabrics, like silk, will not even hold a knot. However, it is possible to secure a silk scarf with the fastener. Additionally, as the user moves, knots sometimes become undone. The fastener alleviates this problem because once it is adjusted it stays in place assuring the user a sturdy and comfortable fit.

The instant fastener is also an improvement on the prior art because it is easier to disassemble. It does not create a complicated mass of knots, thus it does not present the problem and difficulty of disassembling a knot. Instead, to disassemble the fastener, the user only has to pull on one of the leather strips and loosen the hold.

The above explanations are provided to illustrate the utility of the invention. And, by no means necessary were these explanations intended to limit the application of this invention to other purposes.

### BRIEF DESCRIPTION OF THE DRAWINGS

FIG. 1A shows a perspective view of a fastener base used in a first embodiment of the invention. FIG. 1B shows a front view of the fastener base and intertwined lace that comprise the fastener. FIG. 1C is a back view of the fastener base and intertwined lace shown in FIG. 1B.

FIG. 2A shows a perspective view of a fastener base used in a second embodiment of the invention. FIG. 2B is a front view of the fastener. FIG. 2C is a back view of the fastener shown in FIG. 2B.

FIG. 3A is a perspective view of a third embodiment of the fastener base. FIG. 3B is a front view of the third embodiment of the fastener. FIG. 3C is a side view of the third embodiment of the invention.

FIG. 4 shows the fastener in use.

FIG. 5 shows a prior art method for securing a scarf or skull cap.

### DETAILED DESCRIPTION OF THE INVENTION

Throughout this disclosure, a fastener base includes an array of holes. The holes are referenced with the column number first and the row number second. This should in no way be considered to be restrictive of the invention and is only for use as a reference tool in teaching the invention to a skilled artisan. It should be understood that various sized arrays of holes may be utilized in practicing the invention. Moreover, while the following embodiments disclose a loop being made between various holes it is to be understood that the lace may be passed through various other holes to create a loop for passing tails of bandannas, scarves or the like through to secure such headgear to the scalp and skull area of a wearer.

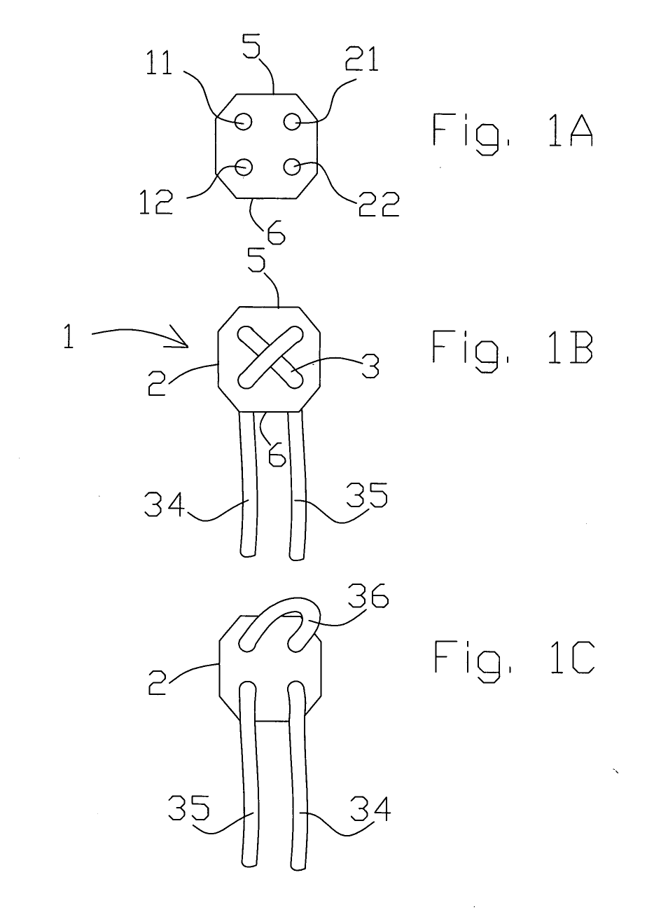

FIG. 1A shows a fastener 1 that comprises a fastener base 2. In this embodiment, a plurality of holes 11, 12, 21, 22, are arranged in a 2 by 2 array. The fastener base includes a top 15 and a bottom 16. In FIG. 1B, a lace 3 is passed through the array of holes. On a front side of the fastener base 2, a first length of the lace 3 passes between hole 11 and hole 22; whilst a second length of the lace 3 passes between hole 12 and hole 21. On a back side of the fastener base 2, a loop is formed between hole 11 and hole 22. A first end 34 of lace 3 extends from hole 22, as shown in FIG. 1C. A second end 35 extends from hole 12.

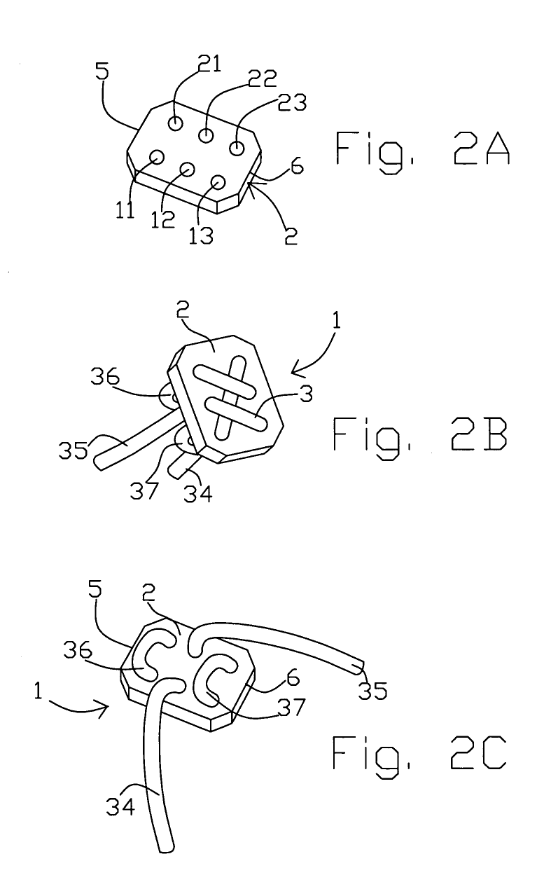

FIG. 2A shows a second embodiment of the fastener 1. In this embodiment, the fastener base 2 includes a third row of holes. These are referenced as hole 13 and hole 23. FIG. 2B shows a first length of the lace 3 passing from hole 11 to hole 22. A second length of the lace 3 passes from hole 12 to hole 23. A third length of the lace 3 passes from hole 21 to hole 13. As shown in FIG. 2C, a first loop 36 is created between holes 11 and 21. A second loop 37 is created between hole 13 and hole 23. First end 34 extends from hole 22. Second end 35 extends from hole 12.

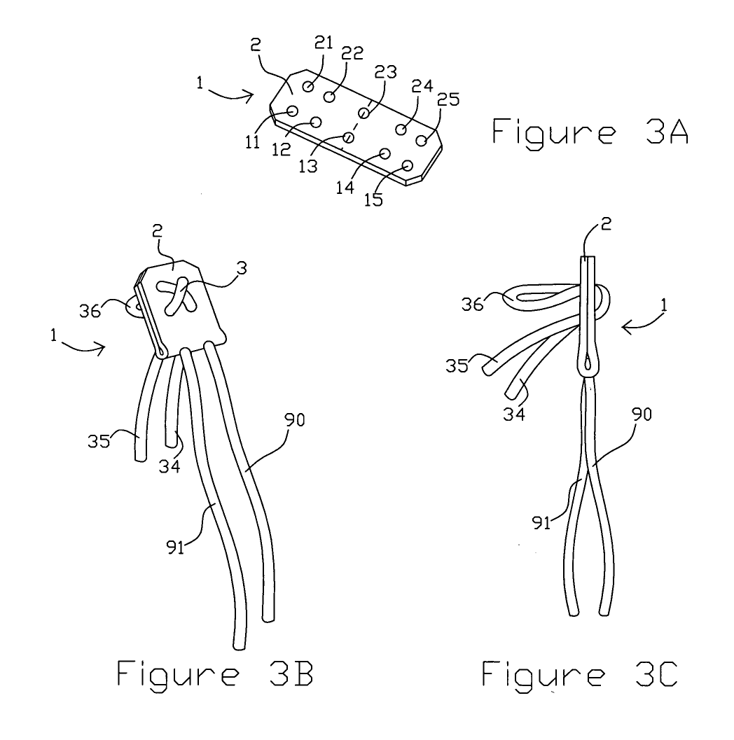

FIG. 3A shows a third embodiment of the fastener 1. In this embodiment, the fastener base includes a fourth and fifth row of holes. A broken line is shown passing through the middle of holes 13 and 23. An ornamental lace 90 passed between these holes and the fastener is then folded along the broken line. Hole 11 overlaps hole 15; while hole 12 overlaps hole 14. Hole 21 overlaps hole 25; while hole 22 overlaps hole 24. A loop is created by hole 15 and hole 25. The first and second ends 34, 35 extend from holes 14 and 24.

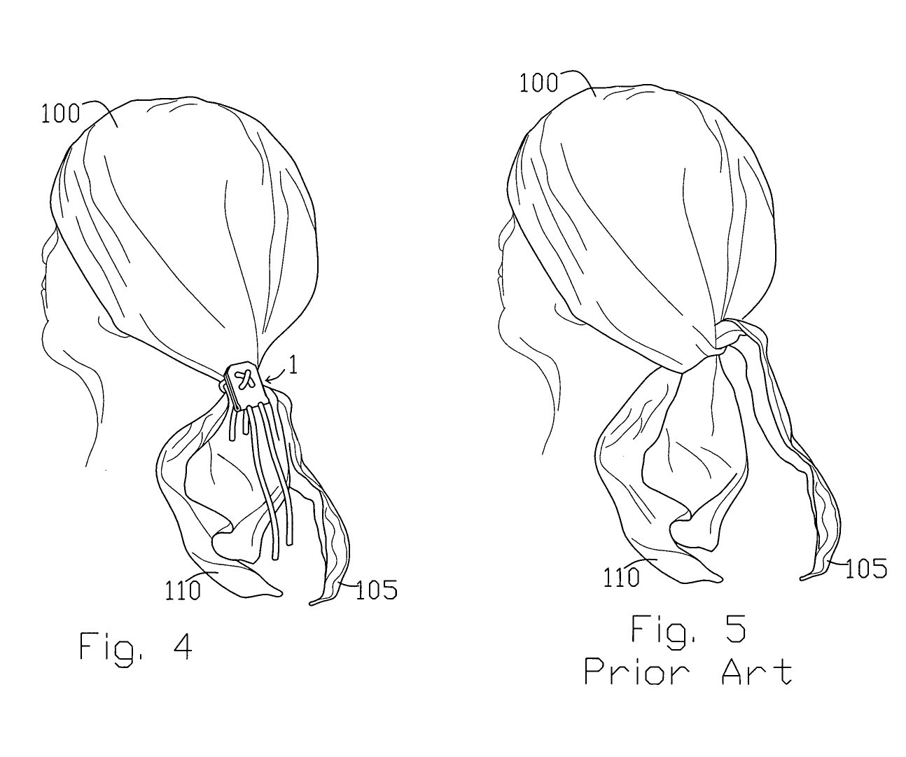

FIG. 4 shows the fastener 1 of the second embodiment in use. Tails 105, 110 of bandana or scarf 100 are passed through first loop 36 and second loop 37. The lace 3 may be loosened and the tightness of the bandanna may be adjusted. Moreover, the slim profile of the fastener will not cause discomfort if the bandanna is worn under a motorcycle helmet.

FIG. 5 is a view of the prior art method for securing a scarf or bandanna 100. The ends 105 and 110 of the bandanna 100 are knotted together causing a bunched lump of material that may cause a pressure point on a region of the scalp when a helmet is worn.

I claim:

1. An adjustable fastening for headgear comprising:
a fastener base having a front side and a back side and including an array of holes, said array of holes comprising at least two columns and two row;
a lace having two ends passing through two holes of the array of holes to create at least a first loop on the backside of the stiff fastener and being crisscrossed on a front side of the stiff fastener, such that the two ends extend from the back side fastener base for tightening and loosening the adjustable fastener.

2. The adjustable fastener of claim 1 wherein said fastener base comprises stiff leather.

3. The adjustable fastener of claim 1 wherein said fastener comprises an array having two columns and three rows of holes.

4. The adjustable fastener of claim 3 wherein said lace passes through said array of holes such that the lace, on the front side of the fastener base passes from a hole in the first column, first row to a hole in the second column, second row, the lace further passing from a hole in the second column, first row to a hole in the first column, third row and said lace passing from a hole in the first column, second row to a hole in the second column, third row.

5. The adjustable fastener of claim 3 wherein, on the backside of the fastener base, the first loop is formed between said hole in the first column, first row and the hole in the second column, first row, a second loop is formed between the hole in the first column, third row and the hole in the second column third row, and two ends of the lace extending from the holes of the second row.

7. The adjustable fastener of claim 1 wherein said fastener base comprises an array having two columns and five rows of holes.

8. The adjustable fastener of claim 7 wherein an ornamental lace passes between the holes in the third row of holes.

9. The adjustable fastener of claim 8 wherein the fastener base is folded over at the third row of holes.

10. The adjustable fastener of claim 1 wherein the first loop is created on a backside of the fastener base between a hole in the first column, fifth row and a hole in the second column, fifth row and free ends of the lace extend from a hole in the first column, fourth row and a hole in the second column, fourth row.

11. The adjustable fastener of claim 1 wherein said lace further comprises a second loop on the backside of the stiff fastener.

12. An adjustable fastening for headgear comprising:
a fastener base having a front side and a back side and including an array of holes, said array of holes comprising two columns and three rows of holes;
a lace having two ends passing through two holes of the array of holes to create at least a first loop on the backside of the stiff fastener and being crisscrossed on a front side of the stiff fastener, such that the two ends extend from the fastener base for tightening and loosening the adjustable fastener,
said lace passes through said array of holes such that the lace, on the front side of the fastener base passes from a hole in the first column, first row to a hole in the second column, second row, the lace further passing from a hole in the second column, first row to a hole in the first column, third row and said lace passing from a hole in the first column, second row to a hole in the second column, third row and,
on the backside of the fastener base, the first loop is formed between said hole in the first column, first row and the hole in the second column, first row, a second loop is formed between the hole in the first column, third row and the hole in the second column third row, and two ends of the lace extending from the holes of the second row.

13. The adjustable fastener of claim 12 wherein said fastener base comprises stiff leather.

14. An adjustable fastening for headgear comprising:
a fastener base having a front side and a back side and including an array of holes, said array of holes comprising at least two columns and two row;
a lace having two ends passing through two holes of the array of holes to create at least a first loop on the backside of the stiff fastener and being crisscrossed on a front side of the stiff fastener, such that the two ends extend from the fastener base for tightening and loosening the adjustable fastener
wherein the first loop is created on a backside of the fastener base between a hole in the first column, first row and a hole in the second column, first row and free ends of the lace extend from a hole in the first column, second row and a hole in the second column, second row.

15. The adjustable fastener of claim 14 wherein said fastener base comprises stiff leather.
